(19) United States
(12) Patent Application Publication
(10) Pub. No.: US 2026/0301698 A1
(43) Pub. Date: Oct. 1, 2026

(54) DISPLAY DEVICE WITH AUTOMATIC BRIGHTNESS ADJUSTMENT MECHANISM AND AUTOMATIC BRIGHTNESS ADJUSTMENT METHOD FOR DISPLAY PANEL THEREOF

(71) Applicant: AUO Corporation, Hsinchu City (TW)

(72) Inventors: Chien-Hsiu PENG, Hsinchu City (TW); Chun-Chia Liu, Hsinchu City (TW); Effendi, Hsinchu City (TW)

(21) Appl. No.: 19/409,432

(22) Filed: Dec. 4, 2025

(30) Foreign Application Priority Data
Mar. 28, 2025 (TW) 114112220

(51) Int. Cl. G09G 3/34

(52) U.S. Cl. CPC G09G 3/3406; G09G 2320/0233; G09G 2320/0626; G09G 2360/144

(57) ABSTRACT

An automatic brightness adjustment method for a display panel is provided. The display panel operates in a current brightness range with a current brightness value. The method includes obtaining an ambient light brightness value, and determining whether the ambient light brightness value exceeds the current brightness range. In response to the ambient light brightness value exceeding the current brightness range, the method includes determining whether a duration for which the ambient light brightness value exceeds the current brightness range reaches a predetermined duration. In response to the duration reaching the predetermined duration, the method includes converting the ambient light brightness value into a target brightness value; adjusting the current brightness value to the target brightness value at a predetermined rate; adjusting the current brightness range to a target brightness range according to the target brightness value; and monitoring the ambient light brightness value based on the target brightness range.

### RELATED APPLICATIONS

This application claims priority to Taiwan Application Serial Number 114112220, filed Mar. 28, 2025, which is herein incorporated by reference.

### BACKGROUND

### Technical Field

The present disclosure relates to a display device and a display panel thereof, and more particularly to a display device with an automatic brightness adjustment mechanism and an automatic brightness adjustment method for the display panel thereof.

### Description of Prior Art

When a display panel performs brightness adjustment in response to changes in ambient light, a drastic variation of the ambient light may cause a drastic variation of the display brightness of the display panel, resulting in screen flicker and visual discomfort to the human eyes. Furthermore, when the display brightness of the display panel is adjusted in an intermittent or non-continuous manner, the adjustment of the display brightness may also reduce the viewing comfort of the display panel.

### SUMMARY

Accordingly, the present disclosure provides a display device with an automatic brightness adjustment mechanism and an automatic brightness adjustment method for a display panel, which enable smooth and continuous adjustment of display brightness of the display panel. The display device and the automatic brightness adjustment method further include a mechanism configured to prevent excessively sensitive brightness adjustment, thereby reducing the impact of sudden brightness variations on user vision and enhancing visual comfort.

The present disclosure provides an automatic brightness adjustment method for a display panel. The automatic brightness adjustment method includes obtaining an ambient light brightness value of an environment where the display panel is located, in which the display panel operates in a current brightness range among multiple brightness ranges and has a current brightness value; and determining whether the ambient light brightness value exceeds the current brightness range. In response to the ambient light brightness value exceeding the current brightness range, the automatic brightness adjustment method further includes determining whether a duration for which the ambient light brightness value exceeds the current brightness range reaches a predetermined duration. In response to the duration reaching the predetermined duration, the method further includes converting the ambient light brightness value into a target brightness value of the display panel; adjusting the current brightness value of the display panel to the target brightness value at a predetermined rate; and adjusting the current brightness range to a target brightness range according to the target brightness value, and monitoring the ambient light brightness value of the environment where the display panel is located based on the target brightness range.

According to one embodiment of the present disclosure, the predetermined duration is determined based on a number of times the ambient light brightness value exceeds the current brightness range, and a period at which the ambient light brightness value is sampled.

According to one embodiment of the present disclosure, the current brightness range has a first predetermined upper limit value and a first predetermined lower limit value, and the automatic brightness adjustment method further includes determining whether an upper limit duration for which the ambient light brightness value exceeds the first predetermined upper limit value reaches the predetermined duration; and determining whether a lower limit duration for which the ambient light brightness value exceeds the first predetermined lower limit value reaches the predetermined duration.

According to one embodiment of the present disclosure, the target brightness range has a second predetermined upper limit value and a second predetermined lower limit value. In response to the target brightness value being greater than the current brightness value, a difference between the second predetermined upper limit value and the second predetermined lower limit value is greater than a difference between the first predetermined upper limit value and the first predetermined lower limit value.

According to one embodiment of the present disclosure, the target brightness range has a second predetermined upper limit value and a second predetermined lower limit value. In response to the target brightness value being less than the current brightness value, a difference between the second predetermined upper limit value and the second predetermined lower limit value is smaller than a difference between the first predetermined upper limit value and the first predetermined lower limit value.

According to one embodiment of the present disclosure, converting the ambient light brightness value into the target brightness value of the display panel further includes referring to a brightness mapping conversion table to map the ambient light brightness value to a corresponding target brightness value, in which the brightness mapping conversion table selectively applies a linear conversion formula, a logarithmic conversion formula, or a multi-stage conversion formula to map the ambient light brightness value to the target brightness value.

According to one embodiment of the present disclosure, the target brightness value is expressed in percentage as a target display brightness ratio, and the linear conversion formula of the target display brightness ratio is expressed as

$$Ltp 1 = \frac{L {t}_{min} + ( L e - L {e}_{min} )}{( L {e}_{max} - L {e}_{min} ) \times ( L {t}_{max} - L {t}_{min} )} ,$$

Ltp1 represents the target display brightness ratio, Ltₘᵢₙ represents a minimum display brightness ratio of the display panel, and Ltₘₐₓ represents a maximum display brightness ratio of the display panel, Le represents the ambient light brightness value, Leₘᵢₙ represents a minimum ambient light brightness value, and Leₘₐₓ represents a maximum ambient light brightness value.

According to one embodiment of the present disclosure, the target brightness value is expressed in percentage as a target display brightness ratio, and the logarithmic conversion formula of the target display brightness ratio is expressed as Ltp2=k×ln(Le)+Lt_{min′}Ltₘᵢₙ represents a minimum display brightness ratio of the display panel, Le represents the ambient light brightness value, and k represents a constant that adjusts the influence of the ambient light brightness value.

According to one embodiment of the present disclosure, in response to a difference between the current brightness value and the target brightness value being smaller than a predetermined value, the predetermined rate is a first adjustment rate; and in response to the difference between the current brightness value and the target brightness value exceeding the predetermined value, the predetermined rate changes from the first adjustment rate to a second adjustment rate.

According to one embodiment of the present disclosure, the predetermined rate is a variable rate, the variable rate gradually increases from a first variable rate to a second variable rate, and then gradually decreases from the second variable rate to the first variable rate.

The present disclosure provides a display device with an automatic brightness adjustment mechanism. The display device with an automatic brightness adjustment mechanism includes a display panel, a light sensing device, and a processing unit. The display panel operates in a current brightness range among multiple brightness ranges and has a current brightness value. The light sensing device is configured to sense an ambient light brightness value of an environment where the display panel is located. The processing unit is coupled to the light sensing device and the display panel and is configured to receive the ambient light brightness value from the light sensing device; and determine whether the ambient light brightness value exceeds the current brightness range of the display panel. In response to the ambient light brightness value exceeding the current brightness range, the processing unit is further configured to determine whether a duration for which the ambient light brightness value exceeds the current brightness range reaches a predetermined duration. In response to the duration reaching the predetermined duration, the processing unit is further configured to convert the ambient light brightness value into a target brightness value of the display panel; adjust the current brightness value of the display panel to the target brightness value at a predetermined rate; and adjust the current brightness range to a target brightness range according to the target brightness value, and monitor the ambient light brightness value of the environment where the display panel is located based on the target brightness range.

According to one embodiment of the present disclosure, the predetermined duration is determined based on a number of times the ambient light brightness value exceeds the current brightness range, and a period at which the light sensing device samples the ambient light brightness value.

According to one embodiment of the present disclosure, the current brightness range has a first predetermined upper limit value and a first predetermined lower limit value, and the processing unit is further configured to determine whether an upper limit duration for which the ambient light brightness value exceeds the first predetermined upper limit value reaches the predetermined duration; and determine whether a lower limit duration for which the ambient light brightness value exceeds the first predetermined lower limit value reaches the predetermined duration.

According to one embodiment of the present disclosure, the target brightness range has a second predetermined upper limit value and a second predetermined lower limit value. In response to the target brightness value being greater than the current brightness value, a difference between the second predetermined upper limit value and the second predetermined lower limit value is greater than a difference between the first predetermined upper limit value and the first predetermined lower limit value.

According to one embodiment of the present disclosure, the target brightness range has a second predetermined upper limit value and a second predetermined lower limit value. In response to the target brightness value being less than the current brightness value, a difference between the second predetermined upper limit value and the second predetermined lower limit value is smaller than a difference between the first predetermined upper limit value and the first predetermined lower limit value.

According to one embodiment of the present disclosure, converting the ambient light brightness value into the target brightness value of the display panel further includes referring to a brightness mapping conversion table to map the ambient light brightness value to a corresponding target brightness value, in which the brightness mapping conversion table selectively applies a linear conversion formula, a logarithmic conversion formula, or a multi-stage conversion formula to map the ambient light brightness value to the target brightness value.

According to one embodiment of the present disclosure, the target brightness value is expressed in percentage as a target display brightness ratio, and the linear conversion formula of the target display brightness ratio is expressed as

$$Ltp 1 = \frac{L {t}_{min} + ( L e - {Le}_{min} )}{( L {e}_{max} - L {e}_{min} ) \times ( L {t}_{max} - L {t}_{min} )} ,$$

Ltp1 represents the target display brightness ratio, Ltₘᵢₙ represents a minimum display brightness ratio of the display panel, and Ltₘₐₓ represents a maximum display brightness ratio of the display panel, Le represents the ambient light brightness value, Leₘᵢₙ represents a minimum ambient light brightness value, and Leₘₐₓ represents a maximum ambient light brightness value.

According to one embodiment of the present disclosure, the target brightness value is expressed in percentage as a target display brightness ratio, and the logarithmic conversion formula of the target display brightness ratio is expressed as Ltp2=k×ln(Le)+Lt_{min′}Ltₘᵢₙ represents a minimum display brightness ratio of the display panel, Le represents the ambient light brightness value, and k represents a constant that adjusts the influence of the ambient light brightness value.

According to one embodiment of the present disclosure, in response to a difference between the current brightness value and the target brightness value being smaller than a predetermined value, the predetermined rate is a first adjustment rate; and in response to the difference between the current brightness value and the target brightness value exceeding the predetermined value, the predetermined rate changes from the first adjustment rate to a second adjustment rate.

According to one embodiment of the present disclosure, the predetermined rate is a variable rate, the variable rate gradually increases from a first variable rate to a second variable rate, and then gradually decreases from the second variable rate to the first variable rate.

### BRIEF DESCRIPTION OF THE DRAWINGS

For a clearer and easier understanding of the above and other objects, features, advantages, and embodiments of the present disclosure, the drawings are described below.

FIG. 1 is a schematic diagram of a display device with an automatic brightness adjustment mechanism according to an embodiment of the present disclosure.

FIG. 2 is a flowchart of an automatic brightness adjustment method for a display panel according to an embodiment of the present disclosure.

FIG. 3 is a schematic diagram of a current brightness range according to an embodiment of the present disclosure.

FIG. 4 is a schematic diagram in which each brightness range has a constant range difference value according to an embodiment of the present disclosure.

FIG. 5 is a schematic diagram in which a range difference value of each brightness range increases with an increase of the brightness range according to an embodiment of the present disclosure.

FIG. 6 is a schematic diagram of a brightness mapping conversion table constructed by applying a linear conversion formula according to an embodiment of the present disclosure.

FIG. 7 is a schematic diagram of a brightness mapping conversion table constructed by applying a logarithmic conversion formula according to an embodiment of the present disclosure.

FIG. 8 is a schematic diagram of a brightness mapping conversion table constructed by applying a multi-stage conversion formula according to an embodiment of the present disclosure.

FIG. 9 is a schematic diagram of a predetermined rate according to an embodiment of the present disclosure.

FIG. 10A is a schematic diagram of a variable rate curve serving as the predetermined rate according to an embodiment of the present disclosure.

FIG. 10B is a brightness variation curve of the display brightness of the display panel adjusted based on the variable rate curve according to an embodiment of the present disclosure.

FIG. 11 is a schematic diagram of an automatic brightness adjustment method that adjusts display brightness of a display panel to a target state in response to a decrease of an ambient light brightness value, according to an embodiment of the present disclosure.

FIG. 12 is a schematic diagram of an automatic brightness adjustment method that adjusts display brightness of a display panel to a target state in response to an increase of an ambient light brightness value, according to an embodiment of the present disclosure.

FIG. 13 is a schematic diagram of an automatic brightness adjustment method in which display brightness of a display panel is not adjusted when a variation time of an ambient light brightness value does not exceed a predetermined duration, according to an embodiment of the present disclosure.

### DETAILED DESCRIPTION

Various embodiments or examples are provided below for implementing various features of the present disclosure. The embodiments of components and configurations described below are examples only and are not intended to be restrictive. In addition, for the purpose of simplification and clarity, the present disclosure repeats reference numerals and/or numbers in each example in the present disclosure, and this repetition does not in itself limit the relationship between various embodiments and/or components discussed.

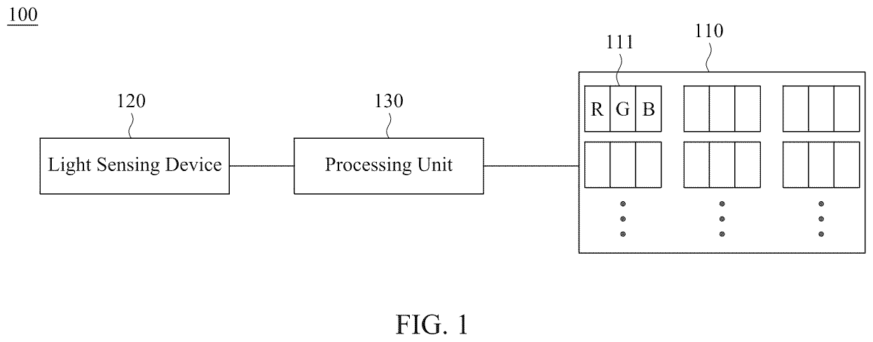

Referring to FIG. 1, FIG. 1 is a schematic diagram of a display device 100 with an automatic brightness adjustment mechanism according to an embodiment of the present disclosure. The display device 100 with the automatic brightness adjustment mechanism includes a display panel 110, a light sensing device 120, and a processing unit 130. The display panel 110 includes multiple unit pixels 111 arranged in rows and columns, and each unit pixel 111 includes a red sub-pixel R, a green sub-pixel G, and a blue sub-pixel B. In the embodiments of the present disclosure, the quantity and arrangement of the red sub-pixels R, green sub-pixels G, and blue sub-pixels B may vary according to actual application requirements of the display panel 110, and the present disclosure is not limited thereto.

The light sensing device 120 is configured to sense an ambient light brightness value Le of an environment where the display panel 110 is located. The light sensing device 120 may be an independent sensing device disposed outside the display panel 110, or may be an embedded sensing module integrated within the display panel 110, and the present disclosure is not limited thereto. When the light sensing device 120 is independently disposed outside the display panel 110, the light sensing device 120 is arranged adjacent to the display panel 110 to obtain a more accurate ambient light brightness value Le.

The processing unit 130 is coupled to the light sensing device 120 and the display panel 110, and is configured to receive the ambient light brightness value Le from the light sensing device 120. When the ambient light brightness value Le exceeds the current brightness range Tc of the display panel 110 for a predetermined duration, the processing unit 130 calculates a target brightness value Lt that is to be converted based on the ambient light brightness value Le. Then, the processing unit 130 adjusts a current brightness value Lc of the display panel 110 to the target brightness value Lt at a predetermined rate V, and adjusts the current brightness range Tc to a target brightness range Tt. A detailed description of the automatic brightness adjustment method of the present disclosure is provided in the following paragraphs, and therefore is omitted herein for brevity.

The display device 100 with the automatic brightness adjustment mechanism of the present disclosure has the capability of sensing the ambient light brightness value Le, and automatically adjusts display brightness of the display panel 110 according to the ambient light brightness value Le. To satisfy human visual comfort requirements, the processing unit 130 is provided with a brightness range determining mechanism and a predetermined duration determining mechanism, which are configured to further determine whether the display panel 110 requires brightness adjustment. As a result, the display panel 110 does not perform frequent brightness adjustments in response to drastic environmental changes, thereby preventing excessive sensitivity of brightness adjustment and avoiding visual discomfort. In addition, the processing unit 130 further controls a dimming rate of the display panel 110 to ensure that the display panel 110 gradually adjusts display brightness to required target brightness value Lt at a continuous and smooth predetermined rate V.

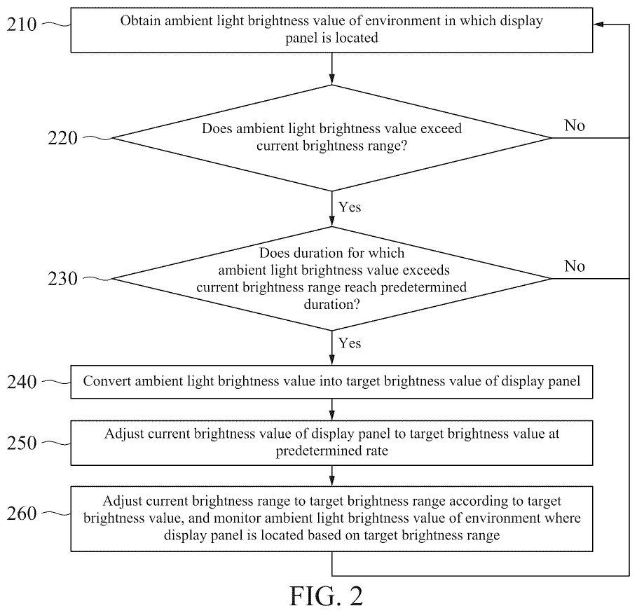

Referring to FIG. 2, FIG. 2 is a flowchart of an automatic brightness adjustment method 200 for a display panel according to an embodiment of the present disclosure. The automatic brightness adjustment method 200 includes Steps 210 to 260 and may be applied to the display device 100 and the display panel 110 thereof illustrated in FIG. 1, or to other systems having similar configurations and functions. The following description explains the automatic brightness adjustment method 200 in conjunction with the display device 100 illustrated in FIG. 1 as an example.

The automatic brightness adjustment method 200 of the present disclosure divides brightness displayable by the display panel 110 into multiple brightness ranges, so that the display panel 110 operates in a corresponding brightness range according to a detected ambient light brightness value Le. In the following steps, a dimming process for converting the display panel 110 from an initial state to a target state is described. The initial state refers to a state that the display panel 110 operates in the current brightness range Tc based on the current ambient light brightness value Le and has the current brightness value Lc. The target state refers to a state in which the display panel 110 operates in the target brightness range Tt and has the target brightness value Lt in response to a variation of the current ambient light brightness value Le. Specifically, the initial state refers to the previous target brightness stored in the system memory, enabling display panel 110 to convert from the previous target brightness to another target brightness in response to the ambient light brightness value.

In Step 210, an ambient light brightness value Le of the environment where the display panel 110 is located is sensed by the light sensing device 120, which is disposed outside the display panel 110 or embedded within the display panel 110.

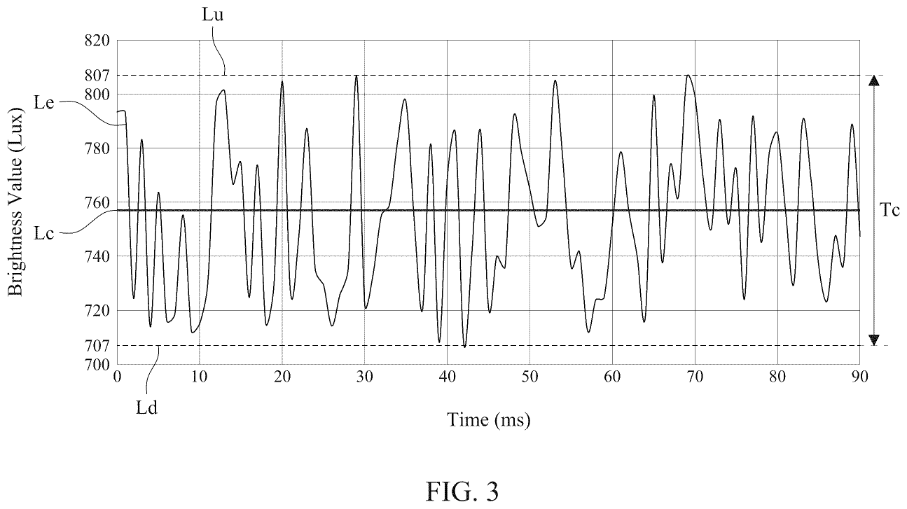

In Step 220, the processing unit 130 determines whether the ambient light brightness value Le exceeds the current brightness range Tc. As shown in FIG. 3, when the display panel 110 has the current brightness value Lc and operates in the current brightness range Tc, the ambient light brightness value Le detected by the light sensing device 120 must fall within the brightness value range corresponding to the current brightness range Tc, that is, between a predetermined upper limit value Lu of 707 lux and a predetermined lower limit value Ld of 807 lux. When the ambient light brightness value Le fluctuates within the current brightness range Tc, the processing unit 130 determines that the ambient light brightness value Le does not exceed the current brightness range Tc, and proceeds back to Step 210 to continuously monitor the ambient light brightness value Le. When the ambient light brightness value Le fluctuates beyond the current brightness range Tc, the automatic brightness adjustment method 200 proceeds to Step 230.

In Step 230, the processing unit 130 further determines whether a duration for which the ambient light brightness value Le exceeds the current brightness range Tc is longer than a predetermined duration. Referring again to FIG. 3, when the processing unit 130 determines that an upper limit duration, during which the ambient light brightness value Le exceeds the predetermined upper limit value Lu, is longer than the predetermined duration, the automatic brightness adjustment method 200 proceeds to Step 240. Conversely, when the processing unit 130 determines that the upper limit duration, during which the ambient light brightness value Le exceeds the predetermined upper limit value Lu, does not exceed the predetermined duration, the processing unit 130 determines that the ambient light brightness value Le represents only a transient or temporary brightening. At this time, the processing unit 130 skips a step of adjusting display brightness of the display panel 110 and returns to Step 210 to continuously monitor the ambient light brightness value Le.

Similarly, when the processing unit 130 determines that a lower limit duration, during which the ambient light brightness value Le exceeds the predetermined lower limit value Ld, is longer than the predetermined duration, the automatic brightness adjustment method 200 proceeds to Step 240. Conversely, when the processing unit 130 determines that the lower limit duration, during which the ambient light brightness value Le exceeds the predetermined lower limit value Ld, does not exceed the predetermined duration, the processing unit 130 determines that the ambient light brightness value Le represents only a transient or temporary darkening. At this time, the processing unit 130 skips the step of adjusting display brightness of the display panel 110 and returns to Step 210 to continuously monitor the ambient light brightness value Le. It should be understood that the range of brightness value illustrated in FIG. 3 is provided for exemplary purposes only and is not intended to limit the setting range of brightness value for each brightness range disclosed in the present disclosure.

In an embodiment of the present disclosure, the predetermined duration depends on a number of times that the ambient light brightness value Le exceeds the current brightness range Tc, and a sampling period at which the light sensing device 120 samples the ambient light brightness value Le. The predetermined duration is expressed by the following equation:

$$Predetermined duration = ( Number of times ambient light brightness value exceeds current brightness range ) \times ( Sampling period of light sensing device ) .$$

For example, but not limited thereto, assume that the number of times the ambient light brightness value Le exceeds the current brightness range Tc is limited to less than 400. Since the light sensing device 120 samples the ambient light brightness value Le once every 10 milliseconds, the predetermined duration is designed as (400)×(10×10⁻³)=4 seconds. When the duration for which the ambient brightness value Le falls below the predetermined lower limit value Ld exceeds 4 seconds, or the duration for which the ambient brightness value Le exceeds the predetermined upper limit value Lu exceeds 4 seconds, it is determined that the display brightness of the display panel 110 needs to be adjusted.

It should be understood that both the number of times the ambient light brightness value Le exceeds the current brightness range Tc, and the sampling period at which the light sensing device 120 samples the ambient light brightness value Le, may be varied according to actual application requirements and specifications of the light sensing device 120, and are not limited thereto in the present disclosure. In some embodiments, a predetermined duration value corresponding to the predetermined lower limit value Ld may be set differently from a predetermined duration value corresponding to the predetermined upper limit value Lu. For example, but not limited thereto, the predetermined duration value corresponding to the predetermined lower limit value Ld may be designed as 4 seconds, while the predetermined duration value corresponding to the predetermined upper limit value Lu may be designed as 3 seconds.

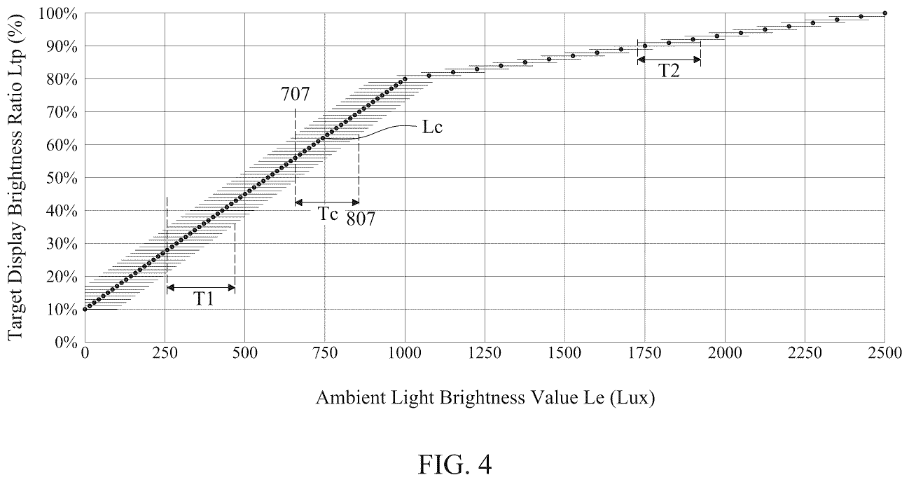

In embodiments of the present disclosure, a range difference value of each brightness range of the display panel 110 may be a constant value, that is, a difference between the predetermined upper limit value Lu and the predetermined lower limit value Ld of each brightness range is constant. As shown in FIG. 4, and taking the current brightness range Tc shown in FIG. 3 as an example, the predetermined upper limit value Lu is 807 lux and the predetermined lower limit value Ld is 707 lux, so that the range difference value therebetween is 100 lux. When the range difference value of each brightness range of the display panel 110 is set to be a constant value, each brightness range (for example, the brightness range T1 and the brightness range T2) has the same range difference value of 100 lux, and the same applies to other brightness ranges indicated by dashed lines that are not labeled.

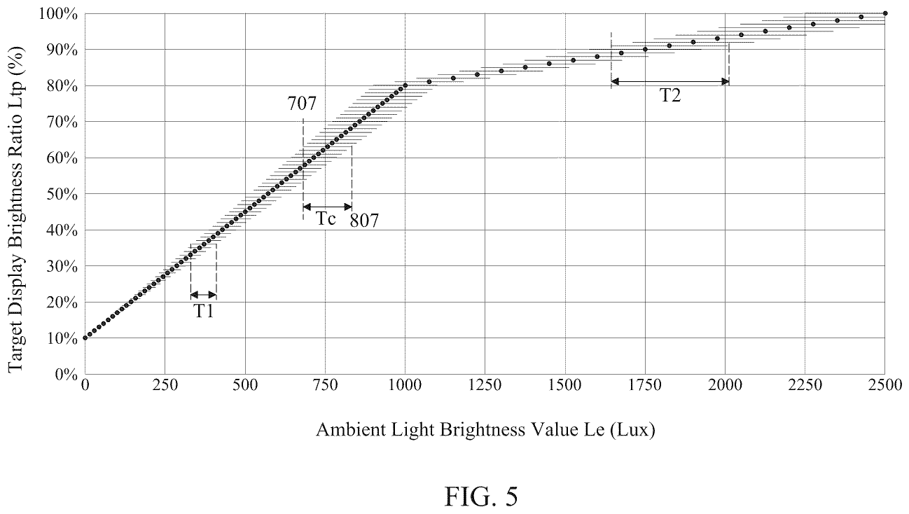

In embodiments of the present disclosure, a range difference value of each brightness range of the display panel 110 may increase as the brightness range becomes brighter, that is, a difference between the predetermined upper limit value Lu and the predetermined lower limit value Ld of each brightness range is gradually increased. As shown in FIG. 5, and taking the current brightness range Tc shown in FIG. 3 as an example, the predetermined upper limit value Lu is 807 lux and the predetermined lower limit value Ld is 707 lux, such that the range difference value therebetween is 100 lux. When the numerical range for each brightness range of the display panel 110 increases as the brightness range becomes brighter, the range difference value of the brightness range T1 is smaller than 100 lux, while the range difference value of the brightness range T2 is greater than 100 lux.

In such embodiments, which allow the brightness adjustment mechanism to reflect sensitivity characteristics of human eyes, being more responsive at low brightness levels and less responsive at high brightness levels. Although the difference between the predetermined upper limit value Lu and the predetermined lower limit value Ld of each brightness range is described as “gradually increasing,” the essence is that the range difference value of a higher brightness range only needs to be greater than that of a lower brightness range. Accordingly, each range difference may be adjusted based on actual application requirements or the visual characteristics of the user.

In embodiments of the present disclosure, a range difference value of each brightness range of the display panel 110 may decrease as the brightness range becomes brighter, that is, a difference between the predetermined upper limit value Lu and the predetermined lower limit value Ld of each brightness range is gradually decreased. Although the difference between the predetermined upper limit value Lu and the predetermined lower limit value Ld of each brightness range is described as “gradually decreasing,” the essence is that the range difference value of a higher brightness range only needs to be lower than that of a lower brightness range. Accordingly, each range difference may be adjusted based on actual application requirements or the visual characteristics of the user.

Referring back to FIG. 2, in step 240, after determining that the ambient light brightness value Le exceeds the current brightness range Tc and that a duration for which the ambient light brightness value Le exceeds the current brightness range Tc has exceeded the predetermined duration, performing step 240 includes converting the ambient light brightness value Le into a target brightness value Lt of the display panel 110. Specifically, visual comfort of human eyes, user requirements, and specifications and characteristics of the display panel 110 needs to be considered for converting the ambient light brightness value Le to the target brightness value Lt. Furthermore, a brightness mapping conversion table defining a correspondence between the ambient light brightness value Le and the target brightness value Lt may be preconstructed in a memory of the processing unit 130, or stored in an additional storage device.

In an embodiment of the present disclosure, constructing the brightness mapping conversion table includes selectively applying a linear conversion formula, a logarithmic conversion formula, or a multi-stage conversion formula to map the ambient light brightness value Le to the target brightness value Lt. The brightness mapping conversion tables M1 to M3 may be jointly placed in the memory of the processing unit 130 or in the additional storage device, allowing selection of an appropriate conversion method according to actual application conditions and user requirements.

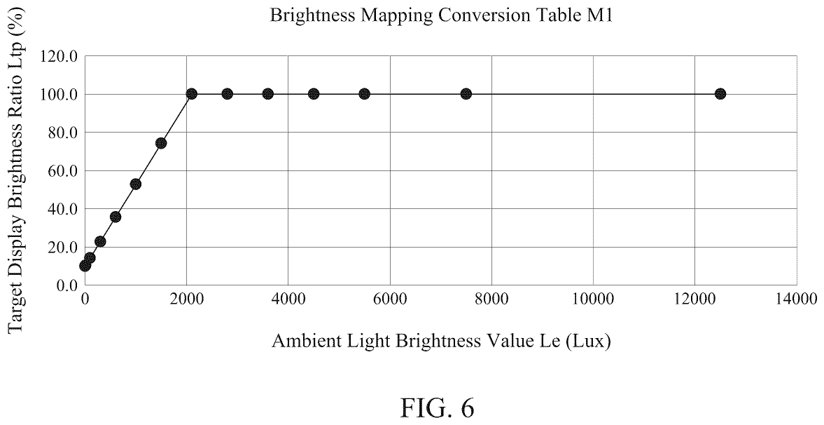

The brightness mapping conversion table M1 shown in FIG. 6 is constructed by applying the linear conversion formula to linearly map the ambient light brightness value Le to a target brightness value Lt1. The target brightness value Lt1 is expressed in percentage (%) as a target display brightness ratio Ltp1, which is obtained by dividing the target brightness value Lt1 by a maximum brightness value of the display panel 110 and multiplying the result by 100%. Based on the linear conversion formula, the target display brightness ratio Ltp1 is expressed as following:

$$L t p 1 = \frac{L {t}_{min} + ( L e - L {e}_{min} )}{( L {e}_{max} - L {e}_{min} ) \times ( L {t}_{max} - L {t}_{min} )} .$$

In the equation, Ltₘᵢₙ represents a minimum display brightness ratio (%) of the display panel 110, and Ltₘₐₓ represents a maximum display brightness ratio (%) of the display panel 110. Le represents the ambient light brightness value, Leₘᵢₙ represents a minimum ambient light brightness value, and Leₘₐₓ represents a maximum ambient light brightness value. By setting the minimum display brightness ratio Ltₘᵢₙ and the maximum display brightness ratio Ltₘₐₓ of the display panel 110, as well as the minimum ambient light brightness value Leₘᵢₙ corresponding to the minimum display brightness ratio Ltₘᵢₙ and the maximum ambient light brightness value Leₘₐₓ corresponding to the maximum display brightness ratio Ltₘₐₓ, the brightness mapping conversion table M1 shown in FIG. 6 may be constructed based on the linear conversion formula, thereby satisfying a linear mapping relationship between the ambient light brightness value Le and the target brightness value Lt1.

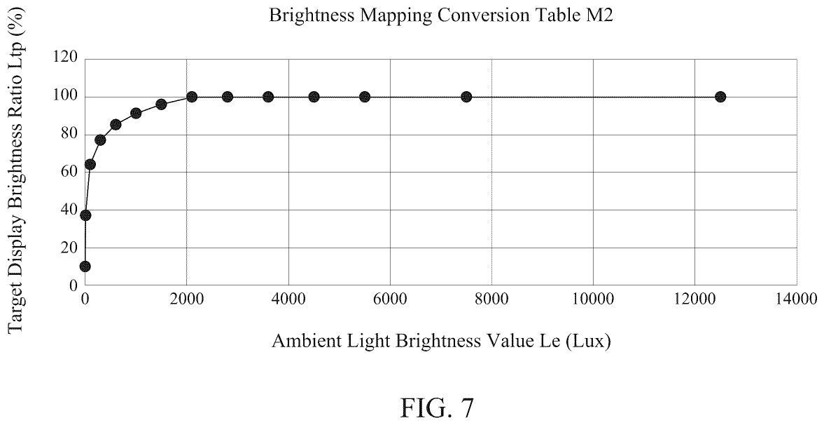

The brightness mapping conversion table M2 of FIG. 7 is constructed by applying the logarithmic conversion formula to map the ambient light brightness value Le logarithmically to a target brightness value Lt2. The target brightness value Lt2 is expressed in percentage (%) as a target display brightness ratio Ltp2, which is obtained by dividing the target brightness value Lt2 by the maximum brightness value of the display panel 110 and multiplying the result by 100%. Based on the logarithmic conversion formula, the target display brightness ratio Ltp2 is expressed as following:

$$Ltp 2 = k \times ln ( L e ) + {Lt}_{min} .$$

In the equation, Ltₘᵢₙ represents a minimum display brightness ratio of the display panel 110, Le represents the ambient light brightness value, and k represents a constant that adjusts the influence of the ambient light brightness value Le. By setting the minimum display brightness ratio Ltₘᵢₙ and the maximum display brightness ratio Ltₘₐₓ of the display panel 110, as well as the minimum ambient light brightness value Leₘᵢₙ corresponding to the minimum display brightness ratio Ltₘᵢₙ and the maximum ambient light brightness value Leₘₐₓ corresponding to the maximum display brightness ratio Ltₘₐₓ, the brightness mapping conversion table M2 shown in FIG. 7 can be constructed based on the logarithmic conversion formula, thereby satisfying a logarithmic mapping relationship between the ambient light brightness value Le and the target brightness value Lt2.

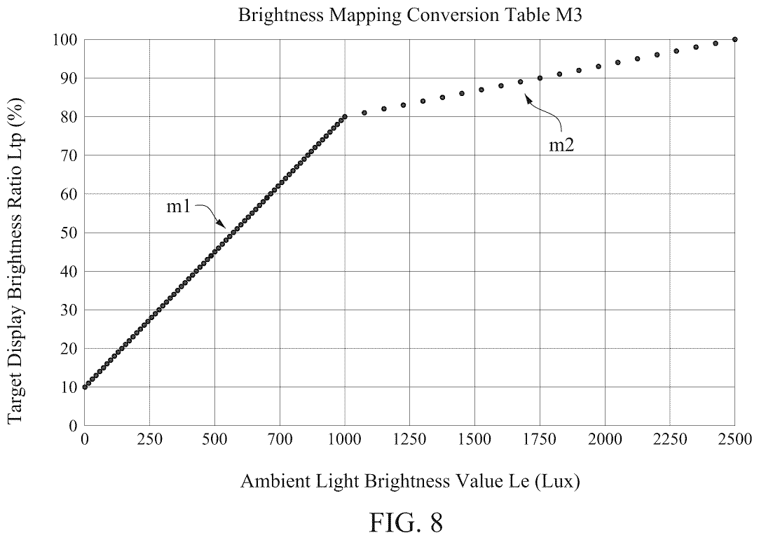

The brightness mapping conversion table M3 of FIG. 8 is constructed by applying the multi-stage conversion formula to map the ambient light brightness value Le to a target brightness value Lt3 according to various stages. In the example shown in FIG. 8, the brightness mapping conversion table M3 includes two conversion stages. When the ambient light brightness value Le ranges from 0 lux to 1000 lux, a first-stage conversion slope m1 is applied. When the ambient light brightness value Le is greater than 1000 lux, a second-stage conversion slope m2 is applied. Through the use of different conversion slopes in respective stages, the ambient light brightness value Le may be mapped to the target brightness value Lt3 in accordance with varying brightness conditions. It should be understood that, to better meet user requirements, the multi-stage conversion formula may include more conversion slopes, and the present disclosure is not limited thereto.

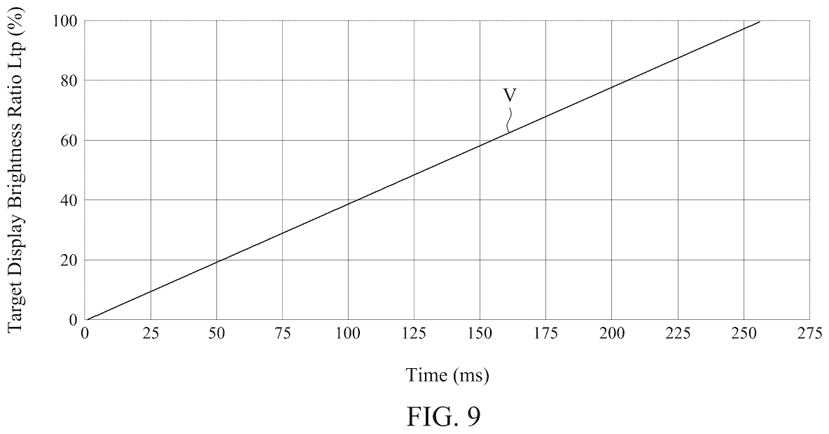

After performing step 240 to obtain the target brightness value Lt to be converted, step 250 is performed to adjust the current brightness value Lc of the display panel 110 to the target brightness value Lt at a predetermined rate V. As shown in FIG. 9, the target brightness value Lt of the display panel 110 is expressed in percentage (%) as the target display brightness ratio Ltp. When the current display brightness ratio is 25%, the target display brightness ratio Ltp is 37%, and the predetermined rate V is set to 0.004% per millisecond (ms), this indicates that the display brightness of the display panel 110 is adjusted at the rate of 0.004% of the display brightness ratio per millisecond, and the adjustment continues until the current display brightness ratio increases from 25% to the target display brightness ratio Ltp of 37%. In embodiments of the present disclosure, setting the predetermined rate V to less than or equal to 0.004% per millisecond allows the display brightness of the display panel 110 to be smoothly and gradually adjusted, thereby preventing excessively fast brightness changes that may cause visual discomfort to human eyes.

In some embodiments, the predetermined rate V may vary depending on a magnitude of the required brightness adjustment, while maintaining visual comfort for human eyes. For example, when a difference between the current brightness value Lc and the target brightness value Lt is less than a predetermined threshold (i.e., the required brightness adjustment is small or within an acceptable range), the predetermined rate V is set to a first adjustment rate. However, when the difference between the current brightness value Lc and the target brightness value Lt exceeds the predetermined threshold (i.e., the required brightness adjustment is relatively large), the predetermined rate V is changed from the first adjustment rate to a second adjustment rate, so as to increase a brightness adjustment speed and reduce a time required for the display panel 110 to reach the target brightness value Lt from the current brightness value Lc.

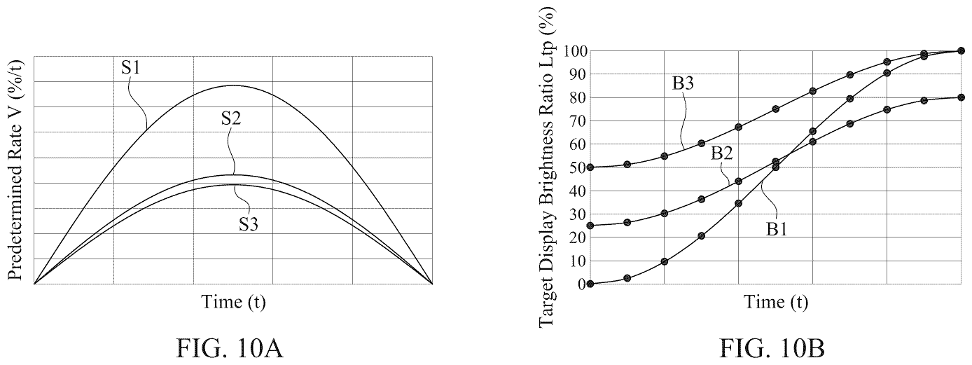

In some embodiments, the predetermined rate V for adjusting the brightness of the display panel 110 is a variable rate. FIG. 10A illustrates three example variable rate curves S1 to S3. The variable rate curve S1 corresponds to a case where a magnitude of the required brightness adjustment is relatively large, such that a variation range of the predetermined rate V is greater and a brightness adjustment speed is faster. The variable rate curve S2 corresponds to a case where the magnitude is smaller, and the variable rate curve S3 corresponds to a case where the magnitude is the smallest, such that variation ranges of the predetermined rate V are smaller and brightness adjustment speeds are slower. As shown, each of the variable rate curves S1 to S3 increases from a first variable rate (an initial rate) to a second variable rate (a peak rate), and then decreases from the second variable rate back to the first variable rate. It should be understood that setting the initial rate to zero in FIG. 10A is merely an example for illustrating the change of the variable rate curves. In fact, the present disclosure does not require the initial rate to start from zero.

From the variations of the variable rate curves S1 to S3, it can be observed that, when the display brightness of the display panel 110 begins to be adjusted, a brightness adjustment speed gradually accelerates. As the display brightness approaches the target brightness value Lt, the brightness adjustment speed gradually decelerates. Accordingly, the entire dimming process exhibits a slow-fast-slow adjustment pattern, thereby enhancing visual comfort for human eyes.

FIG. 10B illustrates brightness variation curves B1 to B3, which respectively correspond to the variable rate curves S1 to S3. It can be observed that the variable rate curve S1 corresponds to a case where a magnitude of the required brightness adjustment is relatively large (for example, the target display brightness ratio Ltp varies from 0% to 100%). Accordingly, in such case, the brightness variation curve B1 exhibits a greater change in the target display brightness ratio Ltp due to a faster brightness adjustment speed corresponding to the variable rate curve S1, and the brightness variation follows a slow-fast-slow pattern consistent with the variation of the brightness adjustment speed, appearing gentle-steep-gentle throughout the adjustment process.

The variable rate curve S3 corresponds to a case where a magnitude of the required brightness adjustment is relatively small (for example, the target display brightness ratio Ltp varies from 50% to 100%). In such case, the brightness variation curve B3 exhibits a slower change in the target display brightness ratio Ltp due to a slower brightness adjustment speed corresponding to the variable rate curve S3. Similarly, the brightness variation follows a slow-fast-slow pattern, appearing gentle-steep-gentle throughout the adjustment process. Interpretation of the brightness variation curve B2 is the same as that of the brightness variation curves B1 and B3, and therefore its description is omitted herein for brevity.

Referring back to FIG. 2, in step 260, the current brightness range Tc is adjusted to a target brightness range Tt based on the target brightness value Lt, so that the ambient light brightness value Le of the environment where the display panel 110 is located can thereafter be monitored according to the target brightness range Tt. Specifically, the target brightness range Tt also includes a predetermined upper limit value Lu and a predetermined lower limit value Ld as previously described. When the current brightness value Lc is adjusted to the target brightness value Lt in response to a change in the ambient light brightness value Le, the current brightness range Tc is simultaneously adjusted to the target brightness range Tt. Thereafter, the method returns to step 210, in which the ambient light brightness value Le is monitored again according to the predetermined upper limit value Lu and the predetermined lower limit value Ld of the target brightness range Tt. Accordingly, the automatic brightness adjustment method 200 for the display panel according to the present disclosure is substantially completed.

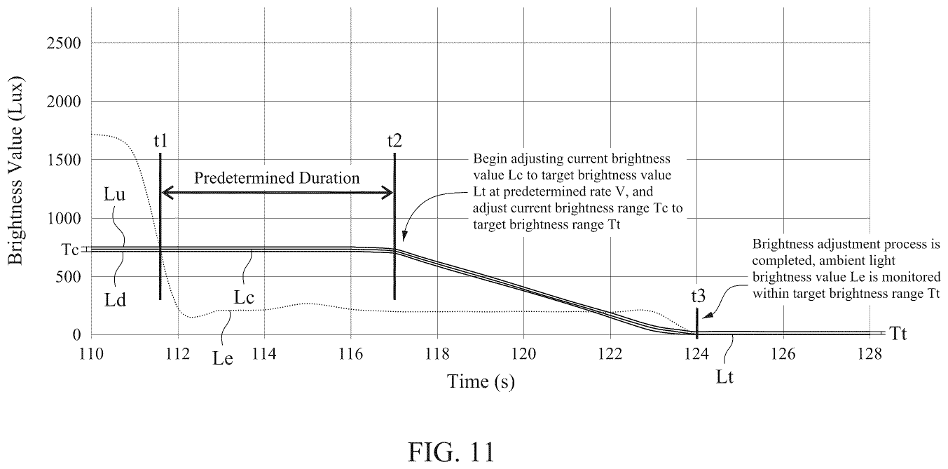

FIG. 11 is a schematic diagram showing how the automatic brightness adjustment method 200 of the present disclosure adjusts the display brightness of the display panel 110 to a target state in response to a decrease in the ambient light brightness value Le.

At time point t1, the ambient light brightness value Le exceeds the predetermined lower limit value Ld of the current brightness range Tc, and the processing unit 130 starts calculating whether a lower limit duration for which the ambient light brightness value Le exceeds the current brightness range Tc has exceeded a predetermined duration.

At time point t2, the lower limit duration for which the ambient light brightness value Le exceeds the current brightness range Tc has reached the predetermined duration. Accordingly, the processing unit 130 begins adjusting the current brightness value Lc of the display panel 110 to the target brightness value Lt at the predetermined rate V and adjusts the current brightness range Tc to the target brightness range Tt.

At time point t3, the brightness adjustment process reaches a stable state, such that the display brightness of the display panel 110 has been adjusted to the target brightness value Lt, while the current brightness range Tc has been adjusted to the target brightness range Tt. It should be noted that, in the stabilized target state, the ambient light brightness value Le lies between the predetermined upper limit value Lu and the predetermined lower limit value Ld of the target brightness range Tt, so that the ambient light brightness value Le is monitored based on the predetermined upper limit value Lu and the predetermined lower limit value Ld of the target brightness range Tt.

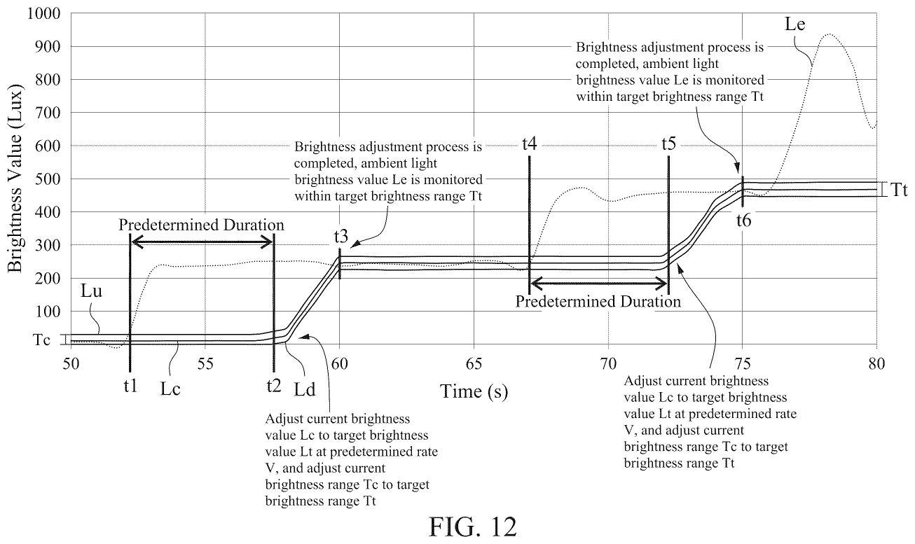

FIG. 12 is a schematic diagram showing how the automatic brightness adjustment method 200 of the present disclosure adjusts the display brightness of the display panel 110 to a target state in response to an increase in the ambient light brightness value Le.

At time point t1, the ambient light brightness value Le exceeds the predetermined upper limit value Lu of the current brightness range Tc, and the processing unit 130 starts calculating whether an upper limit duration for which the ambient light brightness value Le exceeds the current brightness range Tc exceeds a predetermined duration.

At time point t2, the upper limit duration for which the ambient light brightness value Le exceeds the current brightness range Tc has reached the predetermined duration. Accordingly, the processing unit 130 begins adjusting the current brightness value Lc of the display panel 110 to the target brightness value Lt at the predetermined rate V and adjusts the current brightness range Tc to the target brightness range Tt.

At time point t3, the brightness adjustment process reaches a stable state. At this time, the display brightness of the display panel 110 has been adjusted to the target brightness value Lt in response to a first increase of the ambient light brightness value Le, and the current brightness range Tc has been adjusted to the target brightness range Tt.

In the embodiment of the disclosure, the automatic brightness adjustment method 200 may operate as a continuous monitoring process. Time points t4 to t6 function similarly to time points t1 to t3, such that by continuously monitoring the ambient light brightness value Le, the display brightness of the display panel 110 is adjusted in response to a second increase in the ambient light brightness value Le until reaching a stable target state.

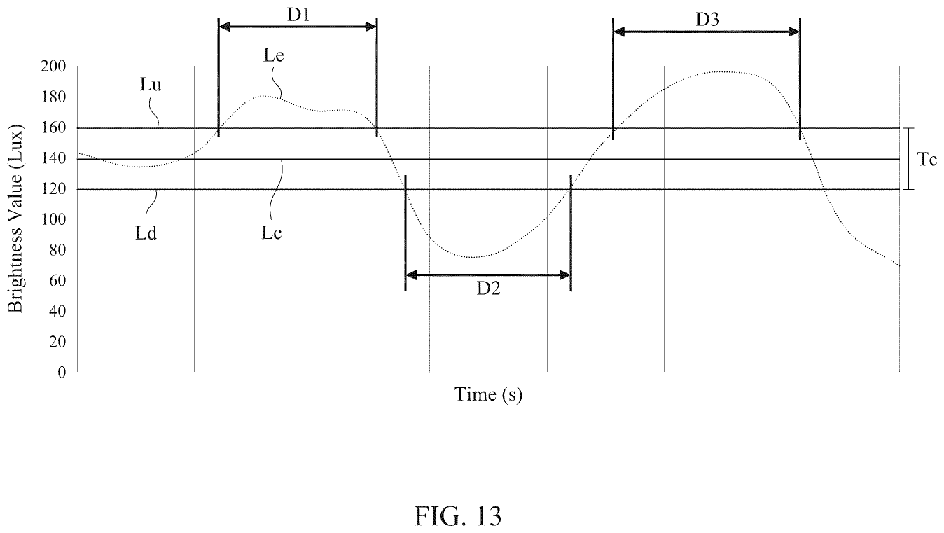

FIG. 13 is a schematic diagram of the automatic brightness adjustment method 200 in which display brightness of the display panel 110 is not adjusted when a variation time of the ambient light brightness value Le does not exceed a predetermined duration. Although the ambient light brightness value Le temporarily exceeds the current brightness range Tc, upper limit durations D1 and D3 during which the ambient light brightness value Le exceeds the predetermined upper limit value Lu of the current brightness range Tc do not reach the predetermined duration. Therefore, the display brightness of the display panel 110 remains at the current brightness value Lc, and monitoring of the ambient light brightness value Le continues based on the current brightness range Tc.

Similarly, lower limit duration D2 during which the ambient light brightness value Le exceeds the predetermined lower limit value Ld of the current brightness range Tc does not reach the predetermined duration. Accordingly, the display brightness of the display panel 110 remains at the current brightness value Lc, and monitoring of the ambient light brightness value Le continues based on the current brightness range Tc.

In summary, the display device with an automatic brightness adjustment mechanism and the automatic brightness adjustment method for the display panel of the present disclosure implement a brightness range determination mechanism and a predetermined duration determination mechanism to further determine whether brightness adjustment of the display panel is required. This prevents the display panel from frequently adjusting its brightness in response to dramatic environmental changes, which could otherwise result in excessive adjustment sensitivity and visual discomfort. Additionally, a brightness adjustment rate control mechanism is provided to adjust the brightness of the display panel smoothly and continuously, thereby reducing the impact of sudden brightness changes on vision of users and enhancing visual comfort.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. An automatic brightness adjustment method for a display panel, comprising:
obtaining an ambient light brightness value of an environment in which the display panel is located, wherein the display panel operates in a current brightness range among a plurality of brightness ranges and has a current brightness value; and
determining whether the ambient light brightness value exceeds the current brightness range, and in response to the ambient light brightness value exceeding the current brightness range, the automatic brightness adjustment method further comprises:
determining whether a duration for which the ambient light brightness value exceeds the current brightness range reaches a predetermined duration, and in response to the duration reaching the predetermined duration, the method further comprises:
converting the ambient light brightness value into a target brightness value of the display panel;
adjusting the current brightness value of the display panel to the target brightness value at a predetermined rate; and
adjusting the current brightness range to a target brightness range according to the target brightness value, and monitoring the ambient light brightness value of the environment where the display panel is located based on the target brightness range.

2. The automatic brightness adjustment method of claim 1, wherein the predetermined duration is determined based on a number of times the ambient light brightness value exceeds the current brightness range, and a period at which the ambient light brightness value is sampled.

3. The automatic brightness adjustment method of claim 1, wherein the current brightness range has a first predetermined upper limit value and a first predetermined lower limit value, the automatic brightness adjustment method further comprises:
determining whether an upper limit duration for which the ambient light brightness value exceeds the first predetermined upper limit value reaches the predetermined duration; and
determining whether a lower limit duration for which the ambient light brightness value exceeds the first predetermined lower limit value reaches the predetermined duration.

4. The automatic brightness adjustment method of claim 3, wherein the target brightness range has a second predetermined upper limit value and a second predetermined lower limit value, and in response to the target brightness value being greater than the current brightness value, a difference between the second predetermined upper limit value and the second predetermined lower limit value is greater than a difference between the first predetermined upper limit value and the first predetermined lower limit value.

5. The automatic brightness adjustment method of claim 3, wherein the target brightness range has a second predetermined upper limit value and a second predetermined lower limit value, and in response to the target brightness value being less than the current brightness value, a difference between the second predetermined upper limit value and the second predetermined lower limit value is smaller than a difference between the first predetermined upper limit value and the first predetermined lower limit value.

6. The automatic brightness adjustment method of claim 1, wherein converting the ambient light brightness value into the target brightness value of the display panel further comprises:
referring to a brightness mapping conversion table to map the ambient light brightness value to the target brightness value, wherein the brightness mapping conversion table selectively applies a linear conversion formula, a logarithmic conversion formula, or a multi-stage conversion formula to map the ambient light brightness value to the target brightness value.

7. The automatic brightness adjustment method of claim 6, wherein the target brightness value is expressed in percentage as a target display brightness ratio, and the linear conversion formula of the target display brightness ratio is expressed as:
$$Ltp 1 = \frac{L {t}_{min} + ( L e - L {e}_{min} )}{( L {e}_{max} - L {e}_{min} ) \times ( L {t}_{max} - L {t}_{min} )} ,$$
wherein Ltp1 represents the target display brightness ratio, Ltₘᵢₙ represents a minimum display brightness ratio of the display panel, and Ltₘₐₓ represents a maximum display brightness ratio of the display panel, Le represents the ambient light brightness value, Leₘᵢₙ represents a minimum ambient light brightness value, and Leₘₐₓ represents a maximum ambient light brightness value.

8. The automatic brightness adjustment method of claim 6, wherein the target brightness value is expressed in percentage as a target display brightness ratio, and the logarithmic conversion formula of the target display brightness ratio is expressed as:
$$Ltp 2 = k \times ln ( L e ) + L {t}_{min} ,$$
wherein Ltₘᵢₙ represents a minimum display brightness ratio of the display panel, Le represents the ambient light brightness value, and k represents a constant that adjusts influence of the ambient light brightness value.

9. The automatic brightness adjustment method of claim 1, wherein:
in response to a difference between the current brightness value and the target brightness value being smaller than a predetermined value, the predetermined rate is a first adjustment rate; and
in response to the difference between the current brightness value and the target brightness value exceeding the predetermined value, the predetermined rate changes from the first adjustment rate to a second adjustment rate.

10. The automatic brightness adjustment method of claim 1, wherein the predetermined rate is a variable rate, the variable rate gradually increases from a first variable rate to a second variable rate, and then gradually decreases from the second variable rate to the first variable rate.

11. A display device with an automatic brightness adjustment mechanism, comprising:
a display panel operating in a current brightness range among a plurality of brightness ranges and having a current brightness value;
a light sensing device configured to sense an ambient light brightness value of an environment in which the display panel is located; and
a processing unit coupled to the light sensing device and the display panel and configured to:
receive the ambient light brightness value from the light sensing device; and
determine whether the ambient light brightness value exceeds the current brightness range of the display panel, and in response to the ambient light brightness value exceeding the current brightness range, the processing unit is further configured to:
determine whether a duration for which the ambient light brightness value exceeds the current brightness range reaches a predetermined duration, and in response to the duration reaching the predetermined duration, the processing unit is further configured to:
convert the ambient light brightness value into a target brightness value of the display panel;
adjust the current brightness value of the display panel to the target brightness value at a predetermined rate; and
adjust the current brightness range to a target brightness range according to the target brightness value, and monitor the ambient light brightness value of the environment where the display panel is located based on the target brightness range.

12. The display device of claim 11, wherein the predetermined duration is determined based on a number of times the ambient light brightness value exceeds the current brightness range, and a period at which the light sensing device samples the ambient light brightness value.

13. The display device of claim 11, wherein the current brightness range has a first predetermined upper limit value and a first predetermined lower limit value, and the processing unit is further configured to:
determine whether an upper limit duration for which the ambient light brightness value exceeds the first predetermined upper limit value reaches the predetermined duration; and
determine whether a lower limit duration for which the ambient light brightness value exceeds the first predetermined lower limit value reaches the predetermined duration.

14. The display device of claim 13, wherein the target brightness range has a second predetermined upper limit value and a second predetermined lower limit value, and in response to the target brightness value being greater than the current brightness value, a difference between the second predetermined upper limit value and the second predetermined lower limit value is greater than a difference between the first predetermined upper limit value and the first predetermined lower limit value.

15. The display device of claim 13, wherein the target brightness range has a second predetermined upper limit value and a second predetermined lower limit value, and in response to the target brightness value being less than the current brightness value, a difference between the second predetermined upper limit value and the second predetermined lower limit value is smaller than a difference between the first predetermined upper limit value and the first predetermined lower limit value.

16. The display device of claim 11, wherein converting the ambient light brightness value into the target brightness value of the display panel further comprises:
referring to a brightness mapping conversion table to map the ambient light brightness value to the target brightness value, wherein the brightness mapping conversion table selectively applies a linear conversion formula, a logarithmic conversion formula, or a multi-stage conversion formula to map the ambient light brightness value to the target brightness value.

17. The display device of claim 16, wherein the target brightness value is expressed in percentage as a target display brightness ratio, and the linear conversion formula of the target display brightness ratio is expressed as:
$$Ltp 1 = \frac{L {t}_{min} + ( L e - L {e}_{min} )}{( L {e}_{max} - L {e}_{min} ) \times ( L {t}_{max} - L {t}_{min} )} ,$$
wherein Ltp1 represents the target display brightness ratio, Ltₘᵢₙ represents a minimum display brightness ratio of the display panel, and Ltₘₐₓ represents a maximum display brightness ratio of the display panel, Le represents the ambient light brightness value, Leₘᵢₙ represents a minimum ambient light brightness value, and Leₘₐₓ represents a maximum ambient light brightness value.

18. The display device of claim 16, wherein the target brightness value is expressed in percentage as a target display brightness ratio, and the logarithmic conversion formula of the target display brightness ratio is expressed as:
$$Ltp 2 = k \times ln ( L e ) + L {t}_{min} ,$$
wherein Ltₘᵢₙ represents a minimum display brightness ratio of the display panel, Le represents the ambient light brightness value, and k represents a constant that adjusts influence of the ambient light brightness value.

19. The display device of claim 11, wherein:
in response to a difference between the current brightness value and the target brightness value being smaller than a predetermined value, the predetermined rate is a first adjustment rate; and
in response to the difference between the current brightness value and the target brightness value exceeding the predetermined value, the predetermined rate changes from the first adjustment rate to a second adjustment rate.

20. The display device of claim 11, wherein the predetermined rate is a variable rate, the variable rate gradually increases from a first variable rate to a second variable rate, and then gradually decreases from the second variable rate to the first variable rate.
